(19) United States
(12) Patent Application Publication
(10) Pub. No.: US 2003/0024268 A1
(43) Pub. Date: Feb. 6, 2003

(54) Method of producing glass balls

(76) Inventors: Lars Christian Herzbach, Weiterstadt (DE); Christian Schenk, Ingelheim (DE); Hatto Schafer, Nieder-Olm (DE)

Correspondence Address: Pauley Petersen Kinne & Erickson, Suite 365, 2800 W. Higgins Road, Hoffman Estates, IL, 60195, US

(21) Appl. No.: 10/180,914

(22) Filed: Jun. 26, 2002

(30) Foreign Application Priority Data
Jun. 26, 2001 (DE) 101 30 811.6

(51) Int. Cl. C03B 32/00

(52) U.S. Cl. 65/21.1

(57) ABSTRACT

A method of producing glass balls, which method can be used for all types of glass, even for glass balls having a very small diameter. If glass fibers or glass rods are plasticized at least partially at their ends by the effect of heat, if glass portions are separated from the plasticized parts of the glass fibers or glass rods, sprayed or passed through nozzles, and if glass balls are formed by subsequently cooling the separated and sprayed glass portions as a result of minimizing the surface energy, then a complex, mechanical surface-finishing treatment is not required.

### BACKGROUND OF THE INVENTION

1. Field of the Invention

This invention relates to a method of producing glass balls.

2. Description of Related Art

Glass balls are presently produced by complex methods, and this presents difficulties, particularly for glass balls having a very small diameter of less than 1 mm. In addition, known methods are costly because they require finishing treatments.

It is known to cut manageable pieces or pellets from a glass block and then to round them and rough-grind them in a drum. The crude balls thus produced are ground coarsely, ground finely, lapped and polished, for example they are subjected to a plurality of cold finishing treatments. The same disadvantages also exist when cylindrical portions are separated from glass rods as initial components.

To produce glass balls, it is known to use glass rods. When producing the glass rods, constrictions are made which are shaped to form balls. The strand of glass may also be severed by air pressure, so that small particles are sprayed or centrifuged, wherein the particles are shaped to form balls by surface tension. In such case, however, the size of the balls being produced is limited with respect to diameter.

### SUMMARY OF THE INVENTION

One object of this invention is to provide a method of producing glass balls, whereby glass balls, particularly those of a very small diameter, can easily be produced in an economical manner, in large quantities, without requiring any finishing treatment.

### DESCRIPTION OF PREFERRED EMBODIMENTS

This object is achieved, according to this invention, with glass fibers or glass rods that are at least partially plasticized at their ends by the effect of heat. Glass portions are separated from the plasticized parts of the glass fibers or glass rods and sprayed. Glass balls are formed by subsequently cooling the separated and sprayed glass portions by minimizing the surface energy.

This method has one advantage, that any desirable type of glass may be used with the glass fibers or glass rods.

Because of the effect of heat, partial regions of the glass fibers or glass rods can be plasticized to such an extent that the partial regions can easily be separated from the regions of the glass fibers or glass rods which are still solid, and they can be sprayed or passed through nozzles. In such case, the plasticization is preferably effected by introducing the ends of the glass fibers or glass rods into a flame of a gas or plasma burner or into a laser beam, the glass portions being simultaneously separated.

The separated glass portions are sprayed. As a result of the spraying operation, “crude balls” having a very small diameter can also be formed. The separated glass portions can be sprayed by inserting the separated glass portions into nozzles.

The sprayed glass portions are cooled once they have passed through the nozzles, and glass balls are formed by the surface tension, such as by minimizing the surface energy. The sprayed glass portions can be cooled by passing through a long air passage or by collecting the sprayed glass portions in an oil bath.

These method steps of plasticizing, separating, spraying and cooling can be easily accomplished in a continuous manufacturing process. The method eventually permits a plurality of glass balls to be produced economically without requiring any mechanical cold finishing treatment, or by requiring only a substantially smaller amount of any mechanical cold finishing treatment.

German Patent Reference 101 30 811.6, the priority document corresponding to this invention, and its teachings are incorporated, by reference, into this specification.

We claim:

1. A method of producing glass balls, comprising: at least partially plasticizing ends of glass fibers or glass rods by heating, separating glass portions from plasticized parts of the glass fibers or glass rods and spraying or passing through nozzles, and forming the glass balls by subsequently cooling the separated glass portions which have been sprayed and passed through nozzles, by minimizing a surface energy.

2. In the method according to claim 1, wherein the plasticized parts of the glass fibers or glass rods are plasticized by introducing ends of the glass fibers or glass rods into one of a laser beam and a flame of one of a gas burner and a plasma burner.

3. In the method according to claim 2, wherein the separated glass portions are converted into the glass balls by a thermal spraying step.

4. In the method according to claim 3, wherein the separated glass portions are sprayed by inserting the separated glass portions into nozzles.

5. In the method according to claim 4, wherein the sprayed glass portions are cooled by passing through a long air passage.

6. In the method according to claim 4, wherein the sprayed glass portions are collected in an oil bath for cooling.

7. In the method according to claim 6, wherein the glass fibers or glass rods, formed from any desirable types of glass, are used.

8. In the method according to claim 1, wherein the separated glass portions are converted into the glass balls by a thermal spraying step.

9. In the method according to claim 1, wherein the separated glass portions are sprayed by inserting the separated glass portions into nozzles.

10. In the method according to claim 1, wherein the sprayed glass portions are cooled by passing through a long air passage.

11. In the method according to claim 1, wherein the sprayed glass portions are collected in an oil bath for cooling.

12. In the method according to claim 1, wherein the glass fibers or glass rods, formed from any desirable types of glass, are used.
